(19) United States
(12) Patent Application Publication
(10) Pub. No.: US 2018/0132284 A1
(43) Pub. Date: May 10, 2018

(54) METHOD AND APPARATUS FOR TRANSMITTING/RECEIVING DOWNLINK DATA FOR TERMINAL IN IDLE STATE

(71) Applicant: ELECTRONICS AND TELECOMMUNICATIONS RESEARCH INSTITUTE, Daejeon (KR)

(72) Inventor: Sung-Min OH, Daejeon (KR)

(21) Appl. No.: 15/802,717

(22) Filed: Nov. 3, 2017

(30) Foreign Application Priority Data
Nov. 7, 2016 (KR) 10-2016-0147705

(51) Int. Cl. H04W 74/08; H04W 72/04; H04W 72/12

(52) U.S. Cl. CPC H04W 74/0833; H04W 72/0406; H04W 76/048; H04W 72/0453; H04W 72/1289

(57) ABSTRACT

A method and an apparatus for transmitting/receiving downlink data for a terminal in an idle state. The terminal receives a paging message from a base station and obtains a Random Access (RA) preamble index corresponding to an identifier of the terminal from the paging message. Then, the terminal transmits an RA preamble corresponding to the RA preamble index to the base station, receives an RA response message from the base station, and obtains downlink resource allocation information from the RA response message. After that, the terminal receives data from the base station based on the downlink resource allocation information.

### CROSS-REFERENCE TO RELATED APPLICATION

This application claims priority to and the benefit of Korean Patent Application No. 10-2016-0147705, filed in the Korean Intellectual Property Office on Nov. 7, 2016, the entire content of which is incorporated herein by reference.

### BACKGROUND OF THE INVENTION

### 1. Field of the Invention

The present invention relates to downlink data transmitting/receiving, and more particularly, to a method and an apparatus for transmitting/receiving downlink data for a terminal in an idle state.

### 2. Description of Related Art

Terminals that are expected to be applied to services such as a smart meter, home automation, smart health (eHealth), and an environmental sensor are characterized by intermittently transmitting and receiving data of a size. In order to efficiently support a terminal having these characteristics, 3GPP defines a new standard such as Machine Type Communication (MTC) or Narrow Band-Internet of Things (NB-IoT). In particular, the NB-IoT system adopts control plane Cellular Internet of Things Evolved Packet System (CloT EPS) optimization (referred to as a control plane solution) and user plane CloT EPS optimization (referred to as a user plane solution) to efficiently transmit data.

The control plane solution is a method in which a terminal in an idle state piggy-backs data to a radio resource control (RRC) connection setup complete message during an RRC connection setup process to transmit data. The user plane solution is a method of reducing the procedure by storing the user equipment (UE) access stratum context information even after the terminal is in the idle state, and reusing the stored context information when transmitting data.

However, since the above two solutions are defined focusing on simplification of a procedure of uplink data transmission, there is a need for a method for a terminal in an idle state to efficiently receive downlink data.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a method and apparatus for efficiently transmitting and receiving downlink data with a terminal in an idle state.

An exemplary embodiment of the present invention provides a method for a terminal in an idle state to receive downlink data. The method includes: receiving, by the terminal, a paging message from a base station and obtaining a Random Access (RA) preamble index corresponding to an identifier of the terminal from the paging message; transmitting, by the terminal, an RA preamble corresponding to the RA preamble index to the base station; receiving, by the terminal, an RA response message from the base station and obtaining downlink resource allocation information from the RA response message; and receiving, by the terminal, data from the base station based on the downlink resource allocation information.

The obtaining of an RA preamble index may further include recognizing that data are transmitted from the base station if the RA preamble index and a first identifier are included in the paging message, wherein in the receiving of data, the data may be received from the base station.

The paging message may include the RA preamble index and a first identifier, and the RA response message may include downlink resource allocation information for transmitting data, uplink resource allocation information for transmitting feedback information for the data, information for uplink time synchronization, and a second identifier.

The obtaining of downlink resource allocation information may include: determining that the RA preamble transmission is successful if the second identifier included in the RA response message is the same as the first identifier; and obtaining downlink resource allocation information from the RA response message when the RA preamble transmission is successful.

The method may further include: after the receiving of data, decoding, by the terminal, the received data; and transmitting, by the terminal, feedback information including the results of the decoding to the base station based on the uplink resource allocation information obtained from the RA response message.

The first identifier and the second identifier may be a temporary identifier (ID) or a terminal dedicated ID.

Another embodiment of the present invention provides a method for a base station to transmit downlink data to a terminal in an idle state. The method includes: transmitting, by the base station, a paging message that includes a random access (RA) preamble index corresponding to an identifier of the terminal; receiving, by the base station, an RA preamble from the terminal; transmitting, by the base station, an RA response message when the received RA preamble is a preamble corresponding to the RA preamble index included in the paging message; and transmitting, by the base station, data to the terminal.

The method may further include: before the transmitting of a paging message, receiving, by the base station, a paging message; deleting, by the base station, a data indication from the received paging message when there is a user identifier corresponding to the terminal and the data indication in the received paging message; and allocating, by the base station, the RA preamble index and a first identifier corresponding to the user identifier to the received paging message.

The transmitting of a paging message may include transmitting a paging message including a user identifier, an RA preamble index, and a first identifier that correspond to the terminal, wherein the first identifier may be a temporary ID or a terminal dedicated ID.

The transmitting of an RA response message may include transmitting an RA response message including downlink resource allocation information for transmitting data, uplink resource allocation information for transmitting feedback information for the data, and a second identifier.

The second identifier may be the same as the first identifier.

The transmitting of an RA response message may further include calculating a time for uplink time synchronization with the terminal when the RA preamble is received, wherein the RA response message may further include information for uplink time synchronization corresponding to the calculated time.

The transmitting of data may include scrambling data using a temporary ID or a terminal dedicated ID, and transmitting the scrambled data to the terminal.

Yet another embodiment of the present invention provides a terminal for receiving downlink data in an idle state. The terminal includes: a transceiver configured to transmit/receive a signal through an antenna; and a processor connected to the transceiver and configured to perform a downlink data reception process, wherein the processor is configured to obtain a Random Access (RA) preamble index from a paging message that is transmitted from a base station and received by the transceiver, and receive data from the base station based on downlink resource allocation information obtained from an RA response message received from the base station after transmitting the RA preamble to the base station through the transceiver.

The processor may be configured to consider that data are transmitted from the base station when the RA preamble index and a first identifier are included in the paging message, and receive data from the base station based on downlink resource allocation information.

The paging message may include the RA preamble index and a first identifier, the RA response message may include downlink resource allocation information for transmitting data, uplink resource allocation information for transmitting feedback information for the data, information for uplink time synchronization, and a second identifier, and the first identifier and the second identifier may be a temporary identifier (ID) or a terminal dedicated ID.

The processor may be configured to determine that the RA preamble transmission is successful if the second identifier included in the RA response message is the same as the first identifier, and obtain downlink resource allocation information from the RA response.

Yet another embodiment of the present invention provides a base station for transmitting downlink data to a terminal in an idle state. The base station includes: a transceiver configured to transmit/receive a signal through an antenna; and a processor connected to the transceiver and configured to perform a downlink data transmission process, wherein the processor is configured to transmit a paging message that includes a random access (RA) preamble index corresponding to an identifier of the terminal through the transceiver, receive an RA preamble from the terminal, transmit an RA response message when the received RA preamble is a preamble corresponding to the RA preamble index included in the paging message, and transmit data to the terminal through the transceiver.

The processor may be configured to delete a data indication from the paging message received through the transceiver when there is a user identifier corresponding to the terminal and the data indication in the received paging message, allocate the RA preamble index and a first identifier corresponding to the user identifier to the paging message, and transmit the paging message through the transceiver.

The processor may be configured to transmit an RA response message including information on a time for uplink time synchronization with the terminal, downlink resource allocation information for transmitting data, uplink resource allocation information for transmitting feedback information for the data, and a second identifier to the terminal through the transceiver.

### BRIEF DESCRIPTION OF THE DRAWINGS

FIG. 1 shows a procedure of transmitting/receiving downlink data.

FIG. 2 shows a procedure of transmitting/receiving downlink data according to an exemplary embodiment of the present invention.

FIG. 3 shows a flowchart of a method for a terminal to receive downlink data according to an exemplary embodiment of the present invention.

FIG. 4 shows a flowchart of a method for a base station to transmit downlink data according to an exemplary embodiment of the present invention.

FIG. 5 shows a schematic structure of a terminal according to an exemplary embodiment of the present invention.

FIG. 6 shows a schematic structure of a base station according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a terminal may indicate a mobile terminal (MT), a mobile station (MS), an advanced mobile station (AMS), a high reliability mobile station (HR-MS), a subscriber station (SS), a portable subscriber station (PSS), an access terminal (AT), and user equipment (UE), and it may include entire or partial functions of the MT, the MS, the AMS, the HR-MS, the SS, the PSS, the AT, and the UE.

Further, a base station BS may designate an advanced base station (ABS), a high reliability base station (HR-BS), a node B (nodeB), an evolved node B (eNodeB), an access point (AP), a radio access station (RAS), a base transceiver station (BTS), a mobile multihop relay (MMR)-BS, a relay station (RS) for functioning as the base station, a relay node (RN) for functioning as the base station, an advanced relay station (ARS) for functioning as the base station, a high reliability relay station (HR-RS) for functioning as the base station, or a small base station (such as a femto BS, a home node B (HNB), a home eNodeB (HeNB), a pico BS, a macro BS, or a micro BS), and it may include entire or partial functions of the ABS, the node B, the eNodeB, the AP, the RAS, the BTS, the MMR-BS, the RS, the RN, the ARS, the HR-RS, and the small base station.

Hereinafter, a method and an apparatus for transmitting/receiving downlink data according to an exemplary embodiment of the present invention will be described.

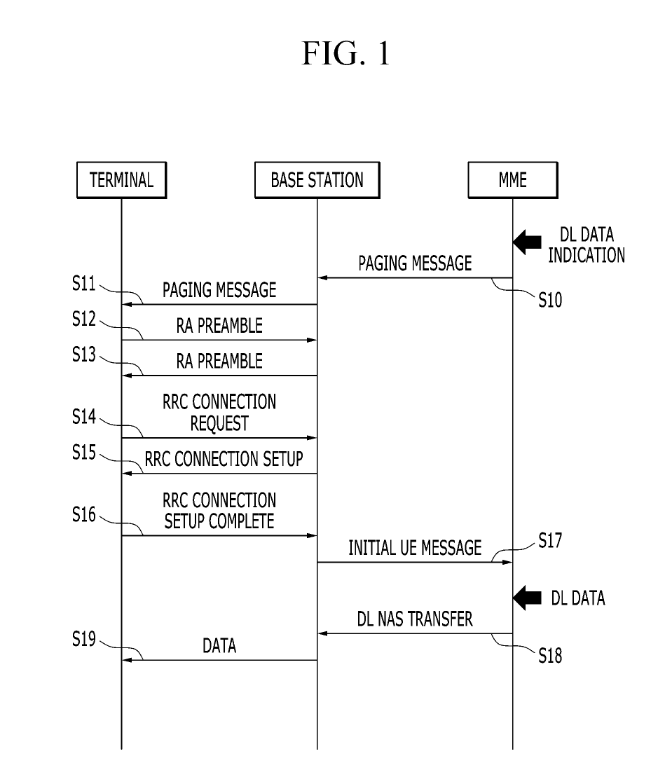

FIG. 1 shows a procedure of transmitting/receiving downlink data. In a Narrow Band-Internet of Things (NB-IoT) system, a procedure of receiving downlink data for a terminal to which a control plane solution, that is, control plane Cellular Internet of Things Evolved Packet System (CloT EPS) optimization, is applied is shown in FIG.1. As shown in FIG. 1, a base station transmits a paging message to a terminal according to a paging message from a Mobile Management Entity (MME) (S10 and S11), and then the terminal performs a random access (RA) procedure (S12 and S13). When receiving a response after transmitting an RA preamble to the base station, the terminal transmits a radio resource control connection request (RRC Connection Request) message to the base station (S14), and if an RRC connection is complete according to an RRC connection setup message from the base station (S15), the terminal transmits an RRC connection setup complete message to the base station (S16). After that, the terminal receives data from the base station (S17-S19).

As above, a terminal in an idle state needs to perform an RRC connection setup procedure so as to receive data. The terminal in an idle state is switched to a connection state and performs a discontinuous reception (DRX) operation. If there are no consecutive data, such as in a machine-type device, the terminal performs a DRX operation for a predetermined time (e.g., drx-inactivity-timer time) and is switched to the idle state. This increases battery consumption.

In the embodiment of the present invention, the terminal in the idle state receives downlink data through a simpler procedure.

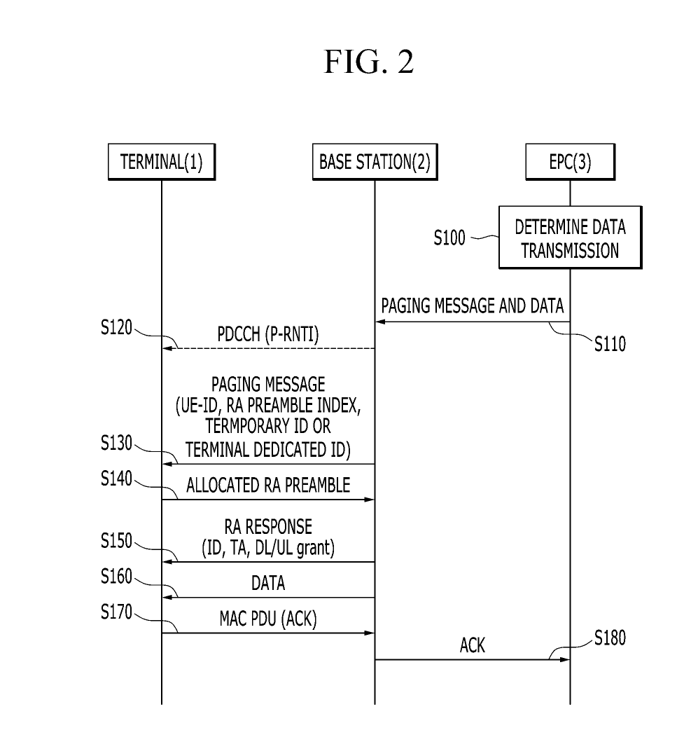

FIG. 2 shows a procedure of transmitting/receiving downlink data according to an exemplary embodiment of the present invention.

When a terminal 1 is in the idle state, if an Evolved Packet Core (EPC) 3 receives data as shown in FIG. 2, a terminal 1 transmits a paging message and data to a base station 2 (S100, S110). The paging message includes a user identifier (also referred to as a user equipment identifier (UE ID)) and an identifier (e.g., data indication) indicating whether a corresponding terminal receives data. If there are a plurality of data, the EPC 3 sequentially transmits the data to the base station 2 in the same order as the UE ID sequence included in the paging message. Here, in order to improve resource efficiency, small data may be classified based on a size by the EPC 3, and the method for transmitting/receiving downlink data according to the embodiment of the present invention may be applied only to the small data. The small data represents data smaller than a predetermined size.

When receiving the paging message, the base station 2 allocates a random access (RA) preamble index and a first identifier (ID) to a list in the received paging message for the terminals having a UE ID and a data indication in the received paging message. Here, the first identifier (ID) is an identifier included in the paging message transmitted from a base station to a terminal, and may be a temporary ID or a terminal dedicated ID. If the first identifier is a dedicated terminal ID already allocated to the corresponding terminal through a procedure such as an Attach and Tracking Area Update (TAU), the terminal and the base station need to store the ID even when the terminal is in the idle state. The base station 2 transmits a paging message including a user identifier (UE ID), an RA preamble index, and a first identifier (ID). The RA preamble index and the first identifier (ID) are mapped and transmitted according to the user identifier (UE ID) (S120).

The terminal 1 receives the paging message from the base station 2 (S130). Specifically, the terminal 1 monitors a Physical Downlink Control Channel (PDCCH) and receives downlink resource allocation information in the PDCCH when detecting a Paging-Radio Network Temporary Identifier (P-RNTI). Then, the terminal 1 receives the paging message by using the received downlink resource allocation information.

The terminal 1 checks whether the RA preamble index and the first identifier (ID) corresponding to its user ID (UE ID) are transmitted when its UE ID is in the received paging message.

The terminal 1 recognizes that data are transmitted to itself when the UE ID, the RA preamble index, and the first identifier (ID) of the terminal 1 are included together in the paging message. When it is recognized that the data are transmitted, the terminal 1 receives data by using the RA preamble index and the first identifier (ID) allocated from the base station.

On the other hand, when the UE ID of the terminal 1, the RA preamble index, and the first identifier (ID) are not included together in the paging message, the terminal 1 performs the existing procedure such as the RRC connection establishment process and receives the data.

Meanwhile, in order to receive data using the RA preamble index and the first identifier (ID) allocated from the base station, the terminal 1 first transmits an RA preamble corresponding to the allocated RA preamble index to the base station 2 (S140).

Upon receiving the RA preamble corresponding to the allocated RA preamble index, the base station 2 calculates a time for synchronizing the uplink synchronization with the terminal 1 having transmitted the RA preamble based on the received RA preamble. Then, the base station 2 transmits an RA response message to the terminal 1. Specifically, the base station 2 includes Timing Alignment (TA) for uplink time synchronization, downlink resource allocation information for transmitting data, uplink resource allocation information for feeding back an acknowledgment (ACK), and a second identifier in an RA response message, and transmits the RA response message to the terminal 1 (S150). The second identifier is the identifier included in the RA response message, and may be either a temporary ID or a terminal dedicated ID. The second identifier may be the same as the first identifier included in the paging message.

The terminal 1 having transmitted the RA preamble monitors the PDCCH, receives the downlink resource allocation information in the PDCCH when an RA-RNTI associated with the transmitted RA preamble is detected, and receives the RA response message from the base station 2 by using the downlink resource allocation information (S150). The terminal 1 can identify the RA response message transmitted to itself based on the value of the RA preamble index having been transmitted by the terminal 1.

The terminal 1 determines whether the second identifier included in the received RA response message is the same as the first identifier (a temporary ID or the already allocated terminal dedicated ID) allocated through the paging message. If the second identifier in the RA response message is the same as the first identifier, the terminal 1 determines that the RA preamble transmission is successful and acquires the TA and the downlink and uplink resource allocation information in the RA response message. On the other hand, if the second identifier in the RA response message is not the same as the first identifier, the terminal 1 considers that the RA preamble transmission has failed and retransmits the RA preamble.

Meanwhile, after transmitting the RA response message, the base station 2 transmits the data to the terminal 1 based on the downlink resource allocation information. At this time, the base station 2 scrambles the data using the temporary ID or the terminal dedicated ID for the terminal 1.

The terminal 1 that has successfully transmitted the RA preamble receives the data based on the downlink resource allocation information and the second identifier acquired from the RA response message (S160). The terminal 1 decodes the received data and feeds the result of decoding back to the base station 2. That is, the terminal 1 feeds back information (ACK/negative-ACK (NACK)) indicating whether the data reception is successful to the base station 2 through the uplink resource corresponding to the uplink resource allocation information included in the RA response message. The terminal 1 may decode the data using the temporary ID or the terminal dedicated ID and feed back information indicating whether the data reception is successful and including the temporary ID or the terminal dedicated ID to the base station 2.

When receiving the ACK from the terminal 1 (S170), the base station 2 transmits ACK information to the EPC 3 (S180). Here, the ACK information transmitted to the EPC 3 may be a Non-Access Stratum (NAS) message including ACK information or a NAS message not including ACK information. Meanwhile, when receiving the NACK from the terminal 1, the base station 2 retransmits the data. At this time, the base station 2 scrambles the PDCCH and allocates the retransmission resources using the temporary ID or the terminal dedicated ID for the terminal 1. The terminal 1 having transmitted the NACK monitors the PDCCH using the temporary ID or the terminal dedicated ID and receives the retransmitted data.

Meanwhile, if the EPC 3 does not receive the ACK message from the base station 2 until a timer expires, the EPC 3 may retransmit the paging message and the data.

According to the embodiment of the present invention, the terminal in the idle state transmits an RA preamble based on an RA preamble index allocated to a paging message and receives an RA response message including the TA and the downlink and uplink resource allocation information, so that data can be received without setting up an RRC connection process.

The method for a terminal to receive downlink data will be described based on the downlink data transmission/reception procedure as described above.

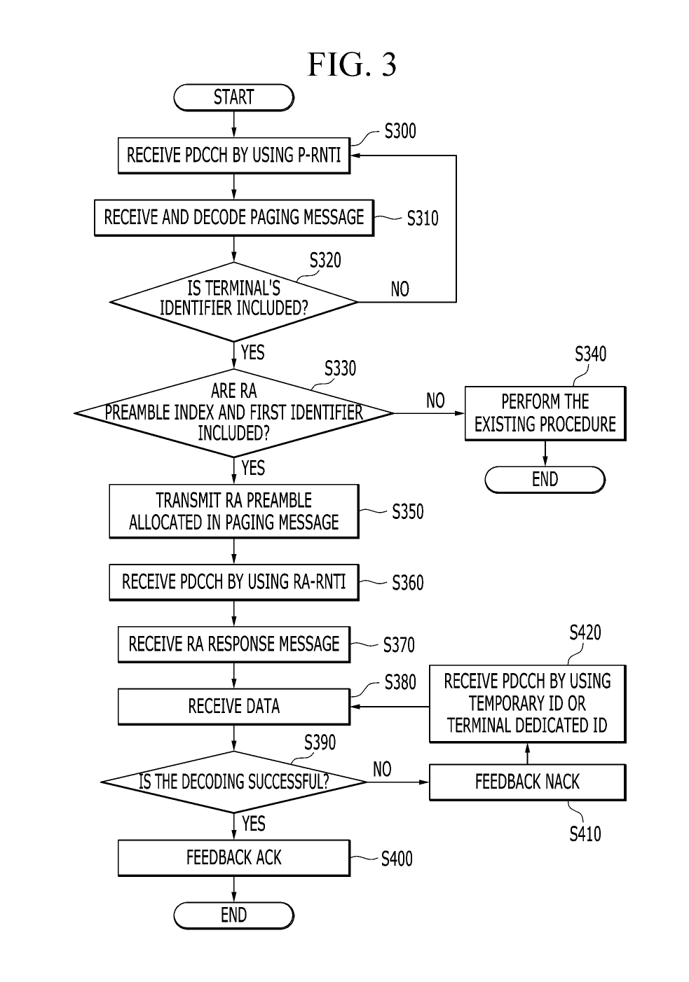

FIG. 3 shows a flowchart of a method for a terminal to receive downlink data according to an exemplary embodiment of the present invention.

The terminal 1 monitors the PDCCH, detects the P-RNTI, and receives and decodes the paging message using the downlink resource allocation information in the PDCCH (S300, S310).

If there is user identifier (UE ID) of the terminal 1 in the decoded paging message (S320) but there is no RA preamble index or the first identifier corresponding to the UE ID (S330), the terminal 1 performs the procedure after the paging message reception (S340). The procedure is based on the procedure shown in FIG. 1, and a detailed description thereof will be omitted here.

On the other hand, if the user identifier (UE ID) of the terminal 1 is in the decoded paging message and there are also an RA preamble index and the first identifier corresponding to the UE ID (S320, S330), the terminal 1 recognizes that the data are transmitted to itself and transmits an RA preamble corresponding to the RA preamble index in the paging message to the base station 2 (S350).

The terminal 1 monitors the PDCCH after transmitting the RA preamble to the base station 2 (S360). If an RA-RNTI associated with the transmitted RA preamble is detected, the terminal 1 receives an RA response message from the base station 2 by using the downlink resource allocation information in the PDCCH (S370).

The terminal 1 receives data from the base station 2 based on the downlink resource allocation information included in the received RA response message (S380). In particular, if the second identifier included in the received RA response message is the same as the first identifier (a temporary ID or the already-allocated terminal dedicated ID) allocated through the paging message, the terminal 1 determines that the RA preamble transmission is successful. If not, the terminal 1 considers that the RA preamble transmission has failed and retransmits the RA preamble.

The terminal 1 receives and decodes the data based on the downlink resource allocation information and the second identifier acquired from the RA response message (S390), and if the decoding is successful, the terminal 1 feeds an ACK message back to the base station 2 (S400). On the other hand, if the decoding fails, the terminal 1 feeds a NACK message back to the base station 2 (S410), monitors the PDCCH based on the downlink resource allocation information and the second identifier, and receives data again (S420).

The method for a base station to transmit downlink data will be described based on the downlink data transmission/reception procedure as described above.

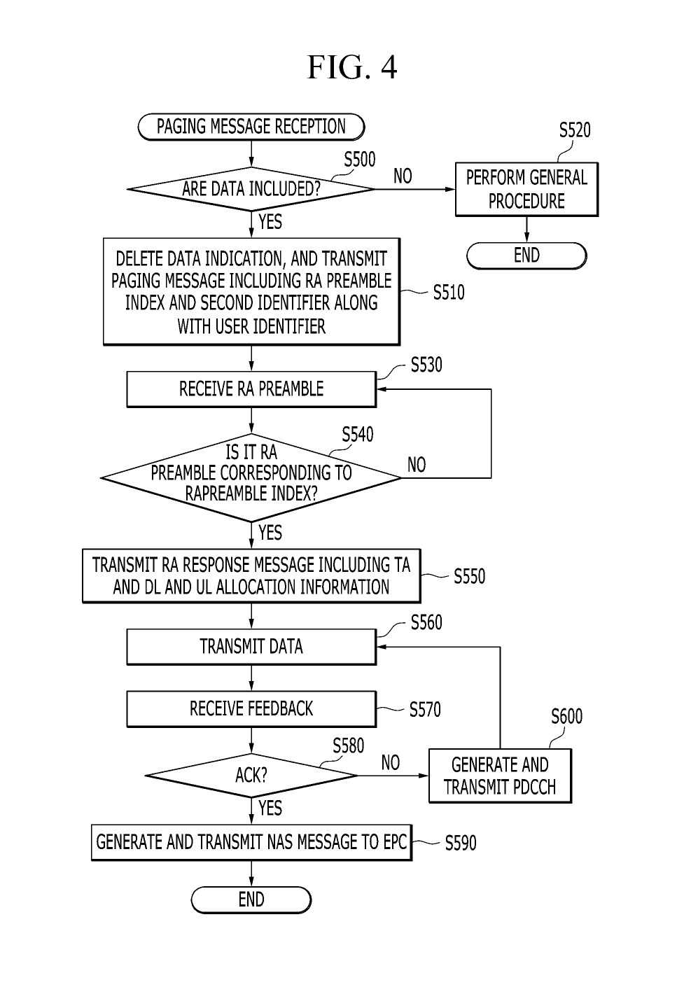

FIG. 4 shows a flowchart of a method for a base station to transmit downlink data according to an exemplary embodiment of the present invention.

The base station 2 receives data along with a paging message from the EPC 3 as shown in FIG. 4, and if there is a data indication in the received paging message (S500), the base station 2 deletes the data indication from the paging message and transmits the paging message including a list in which there is an RA preamble index and a first identifier (a temporary ID or a terminal dedicated ID) together with a user identifier (UE ID) to the terminal 1 (S510). If there is no data indication in the received paging message, the base station 2 performs a general paging reception procedure (S520). Since the general paging reception procedure is known, a detailed description is omitted here.

When the RA preamble is received from the terminal 1 after the paging message is transmitted to the terminal 1 (S530), the base station 2 determines whether the received RA preamble corresponds to the RA preamble index included in the paging message that has been transmitted to the terminal 1 (S540).

If the received RA preamble corresponds to the RA preamble index included in the paging message that has been transmitted to the terminal 1, the base station 2 includes a TA for uplink time synchronization, downlink resource allocation information for transmitting data, uplink resource allocation information for feeding back an ACK, and a second identifier (which may be a temporary ID or a terminal dedicated ID corresponding to the RA preamble index) in an RA response message, and transmits the RA response message to the terminal 1 (S550).

After transmitting the RA response message, the base station 2 transmits data to the terminal 1 based on the downlink resource allocation information (S560). Then, the base station 2 receives a feedback message from the terminal 1 (S570). If the received feedback message is ACK, the base station 2 generates a NAS message including ACK information and transmits it to the EPC 3 (S580, S590). On the other hand, if the received feedback message is a NACK, the base station 2 allocates a retransmission resource to the PDCCH and retransmits the data (S600).

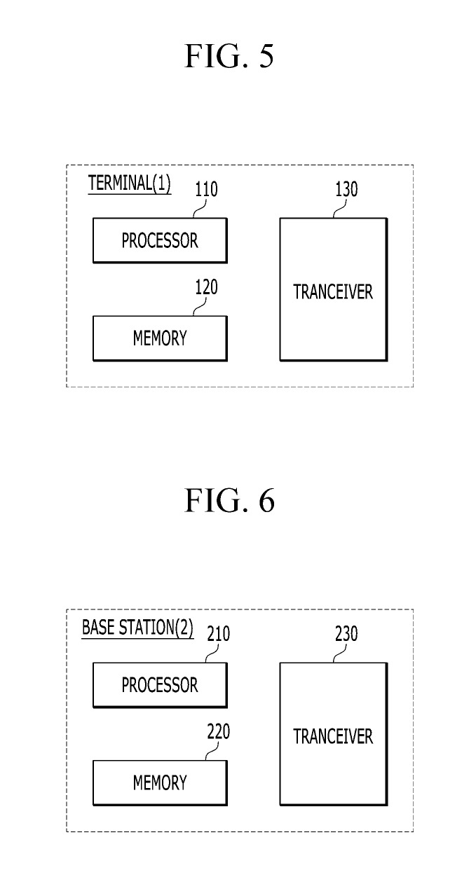

FIG. 5 shows a schematic structure of a terminal according to an exemplary embodiment of the present invention.

As shown in FIG. 5, a terminal 1 according to the embodiment of the present invention includes a processor 110, a memory 120, and a transceiver 130. The processor 110 may be configured to implement the methods described above based on FIGS. 2 and 3.

The memory 120 is connected to the processor 110, and is configured to store various information related to an operation of the processor 11. The memory 120 may store instructions related to operations to be performed by the processor 110, or may temporarily store instructions loaded from a storage device (not shown). The processor 110 may execute the instructions stored or loaded in the memory 120. The processor 110 and the memory 120 are connected to each other through a bus (not shown), and the bus may be connected to an input and output interface (not shown).

FIG. 6 shows a schematic structure of a base station according to an exemplary embodiment of the present invention.

As shown in FIG. 6, a base station 2 according to an exemplary embodiment of the present invention includes a processor 210, a memory 220, and a transceiver 230.

The processor 210 may be configured to implement the operations and methods described above with reference to FIG. 2 and FIG. 4.

The memory 220 is connected to the processor 210, and is configured to store various information related to operations of the processor 210. The memory 220 may store instructions related to operations to be performed by the processor 210, or may temporarily store instructions loaded from a storage device (not shown).

The processor 210 may execute the instructions stored or loaded in the memory 220. The processor 210 and the memory 220 are connected to each other through a bus (not shown), and the bus may be connected to an input and output interface (not shown).

According to an embodiment of the present invention, it is possible to reduce the signaling overhead and battery consumption that may occur when terminals intermittently receive the downlink data. In order to receive downlink data in the prior art, a terminal needs to setup a radio resource control (RRC) connection and then receive data, so that the RRC connection state can be unnecessarily maintained even after receiving intermittent data. However, according to the embodiment of the present invention, since a terminal in an idle state can receive data, that is, data of a small size, without the RRC connection setup process, the signaling overhead due to the existing RRC connection setup process and the battery consumption can be reduced. In addition, in the embodiment of the present invention, the success rate of data transmission can be improved by applying a random access procedure based on a contention-free scheme.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a terminal in an idle state to receive downlink data, the method comprising:
receiving, by the terminal, a paging message from a base station and obtaining a Random Access (RA) preamble index corresponding to an identifier of the terminal from the paging message;
transmitting, by the terminal, an RA preamble corresponding to the RA preamble index to the base station;
receiving, by the terminal, an RA response message from the base station and obtaining downlink resource allocation information from the RA response message; and
receiving, by the terminal, data from the base station based on the downlink resource allocation information.

2. The method of claim 1, wherein:
the obtaining of an RA preamble index further includes recognizing that data are transmitted from the base station if the RA preamble index and a first identifier are included in the paging message, and
in the receiving of data, the data are received from the base station.

3. The method of claim 1, wherein:
the paging message includes the RA preamble index and a first identifier, and
the RA response message includes downlink resource allocation information for transmitting data, uplink resource allocation information for transmitting feedback information for the data, information for uplink time synchronization, and a second identifier.

4. The method of claim 3, wherein the obtaining of downlink resource allocation information includes:
determining that the RA preamble transmission is successful if the second identifier included in the RA response message is the same as the first identifier; and
obtaining downlink resource allocation information from the RA response message when the RA preamble transmission is successful.

5. The method of claim 3, further comprising:
after the receiving of data,
decoding, by the terminal, the received data; and
transmitting, by the terminal, feedback information including the results of the decoding to the base station based on the uplink resource allocation information obtained from the RA response message.

6. The method of claim 3, wherein the first identifier and the second identifier are a temporary identifier (ID) or a terminal dedicated ID.

7. A method for a base station to transmit downlink data to a terminal in an idle state, the method comprising:
transmitting, by the base station, a paging message that includes a random access (RA) preamble index corresponding to an identifier of the terminal;
receiving, by the base station, an RA preamble from the terminal;
transmitting, by the base station, an RA response message when the received RA preamble is a preamble corresponding to the RA preamble index included in the paging message; and
transmitting, by the base station, data to the terminal.

8. The method of claim 7, further comprising:
before the transmitting of a paging message,
receiving, by the base station, a paging message;
deleting, by the base station, a data indication from the received paging message when there is a user identifier corresponding to the terminal and the data indication in the received paging message; and
allocating, by the base station, the RA preamble index and a first identifier corresponding to the user identifier to the received paging message.

9. The method of claim 7, wherein the transmitting of a paging message includes transmitting a paging message including a user identifier, an RA preamble index, and a first identifier that correspond to the terminal, the first identifier being a temporary ID or a terminal dedicated ID.

10. The method of claim 9, wherein the transmitting of an RA response message includes transmitting an RA response message including downlink resource allocation information for transmitting data, uplink resource allocation information for transmitting feedback information for the data, and a second identifier.

11. The method of claim 10, wherein the second identifier is the same as the first identifier.

12. The method of claim 10, wherein:
the transmitting of an RA response message further includes calculating a time for uplink time synchronization with the terminal when the RA preamble is received, and
the RA response message further includes information for uplink time synchronization corresponding to the calculated time.

13. The method of claim 7, wherein the transmitting of data includes scrambling data using a temporary ID or a terminal dedicated ID, and transmitting the scrambled data to the terminal.

14. A terminal for receiving downlink data in an idle state, comprising:
a transceiver configured to transmit/receive a signal through an antenna; and
a processor connected to the transceiver and configured to perform a downlink data reception process,
wherein the processor is configured to obtain a Random Access (RA) preamble index from a paging message that is transmitted from a base station and received by the transceiver, and receive data from the base station based on downlink resource allocation information obtained from an RA response message received from the base station after transmitting the RA preamble to the base station through the transceiver.

15. The terminal of claim 14, wherein the processor is configured to consider that data are transmitted from the base station when the RA preamble index and a first identifier are included in the paging message, and receive data from the base station based on downlink resource allocation information.

16. The terminal of claim 14, wherein:
the paging message includes the RA preamble index and a first identifier,
the RA response message includes downlink resource allocation information for transmitting data, uplink resource allocation information for transmitting feedback information for the data, information for uplink time synchronization, and a second identifier, and
the first identifier and the second identifier are a temporary identifier (ID) or a terminal dedicated ID.

17. The terminal of claim 16, wherein the processor is configured to determine that the RA preamble transmission is successful if the second identifier included in the RA response message is the same as the first identifier, and obtain downlink resource allocation information from the RA response.
